(19) United States
(12) Patent Application Publication
(10) Pub. No.: US 2016/0041983 A1
(43) Pub. Date: Feb. 11, 2016

(54) LOCAL QUERY RANKING FOR SEARCH ASSIST METHOD AND APPARATUS

(71) Applicant: YAHOO! INC., Sunnyvale, CA (US)

(72) Inventors: Hongbo Deng, San Jose, CA (US); Anlei Dong, Fremont, CA (US); Shenhong Zhu, Santa Clara, CA (US); Jiuhe Gan, Cupertino, CA (US); Yi Chang, Sunnyvale, CA (US)

(21) Appl. No.: 14/453,915

(22) Filed: Aug. 7, 2014

(51) Int. Cl. G06F 17/30

(52) U.S. Cl. CPC G06F 17/3053; G06F 17/3097; G06F 17/30241

(57) ABSTRACT

One or more suggested search query completion alternatives are provided to the user and are selectable by the user in completing the user's search query. The suggested search query completion alternatives may comprise local business query completion suggestions, each of which may correspond to a local business, and general query completion suggestions, each of which may correspond to a general query. A ranking of local business query completion suggestions and general query completion suggestions may be used to identify a number of top-ranked query completion suggestions for presentation to the user. The ranking may use a popularity measure associated with each business and a frequency measure associated with each general query. A popularity associated with a local business may be weighted using a granularity weighting, which may be determined using a local query intent confidence level.

### FIELD OF THE DISCLOSURE

The present disclosure relates to searching, and more particularly to providing suggested search alternatives that take into account popularity of local businesses.

### BACKGROUND

Typically, a user wishing to perform a search using a search engine submits search criteria comprising one or more search terms. In response, the user receives a set of search results, each of which has some relevance to the user's search criteria. For example, a search engine, such as a general web search engine, searches information on the world wide web to find information that satisfies the user's search criteria. Often times, a user's search criteria may be broadly stated resulting in search results that may not be of interest to the user, even though the search results are relevant to the user's search criteria. The user may be forced to refine, or narrow, the search criteria to retrieve more refined set of search results, which may be frustrating to the user. The frustration may be even greater where the user is using a mobile computing device, such as and without limitation a smartphone, personal digital assistant, tablet, etc., which tends to have processing capabilities, displays and/or user interfaces that are not as capable as those available on desktop computers.

### SUMMARY

The present disclosure seeks to address failings in the art and to facilitate searching by providing a search assist. A number of search queries may be related to local businesses, or local business names and, in accordance with one or more embodiments of the present disclosure, the search assist mechanism takes this into account when making suggestions for completing a user's partial search query. The search assist mechanism that takes into account a local business intent of a user's partial search query may be used with any search engine, including a general web search engine. In accordance with one or more such embodiments, one or more suggested alternatives are provided for completing a user's search criteria. The one or more suggested alternatives may be provided to the user as the user is entering the search criteria, so that the user may select one of the suggested alternatives as the search criteria that the user wishes to submit to a search engine.

In accordance with one or more embodiments, the suggested query completion alternatives may comprise one or more local business query completion alternatives, each of which may correspond to a business considered to be local. The one or more local business query completion alternatives may be selected for presentation, e.g., display, to the user as part of the suggested query completion alternatives for the user's partial search query, the suggested query completions may be based on such information as the user's partial search query, the user's geographic location, each business's geographic location and popularity, relevant general search queries and a frequency associated with each general search query. One or more popular local businesses may be presented as suggested local business query completions along with one or more suggested general search query completions.

A ranking of local business query completion suggestions and general query completion suggestions may be used to identify a number of top-ranked query completion suggestions for presentation to the user. The ranking may use a popularity measure associated with each business and a frequency measure associated with each general query. A general query's frequency may be determined using historic information, such as information provided by query logs, which store information about previously-submitted queries, corresponding search results and search result click, or selection, information. A business's popularity may be determined using such information as reviews and/or ratings of the business, comments about the business, number of searches for the business, number of clicks, or selections, of a search result associated with the business, etc. A popularity associated with a local business may be weighted based at least in part on a confidence in the user's local query intent. A local query intent confidence level may be determined using the user's partial search query.

A local business query completion suggestion may correspond to at least one local business, where a determination of what is considered to be a local business may be determined relative to a geographic location of a user providing the partial search query input. Embodiments of the present disclosure may use different levels of granularity in defining what is local, such as and without limitation local may be with respect to a city, a direct market area, a country, etc.

In accordance with one or more embodiments, a method is provided, the method comprising receiving, by at least one computing device, user input indicative of a partial search query; identifying, by the at least one computing device, a set of general queries; identifying, by the at least one computing device, a set of local businesses, each local business is determined to be local to the user; determining, by the at least one computing device, a set of suggested query completions, using the set of general queries and the set of local businesses, the determining using a frequency associated with each general query of the set and a popularity associated each local business of the set; and making, by the at least one computing device, the set of suggested query completions available to the user in response to the user input.

In accordance with one or more embodiments a system is provided, which system comprises at least one computing device comprising one or more processors to execute and memory to store instructions to receive user input indicative of a partial search query; identify a set of general queries; identify a set of local businesses, each local business is determined to be local to the user; determine a set of suggested query completions, using the set of general queries and the set of local businesses, the determining using a frequency associated with each general query of the set and a popularity associated each local business of the set; and make the set of suggested query completions available to the user in response to the user input.

In accordance with yet another aspect of the disclosure, a computer readable non-transitory storage medium is provided, the medium for tangibly storing thereon computer readable instructions that when executed cause at least one processor to receive user input indicative of a partial search query; identify a set of general queries; identify a set of local businesses, each local business is determined to be local to the user; determine a set of suggested query completions, using the set of general queries and the set of local businesses, the determining using a frequency associated with each general query of the set and a popularity associated each local business of the set; and make the set of suggested query completions available to the user in response to the user input.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 provides an overview of components for use in accordance with one or more embodiments of the present disclosure.

FIG. 2 provides an example of a process flow in accordance with one or more embodiments of the present disclosure.

FIG. 3, which comprises FIGS. 3A and 3B, provides another example of a process flow in accordance with one or more embodiments of the present disclosure.

FIG. 4 provides examples of various weights that may be applied to a popularity score in accordance with one or more embodiments of the present disclosure.

FIG. 5 illustrates some components that may be used in connection with one or more embodiments of the present disclosure.

FIG. 6 is a detailed block diagram illustrating an internal architecture of a computing device in accordance with one or more embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. in addition, the term “based on” may be understood as not necessarily intended to convey an exclusive set of factors and may, instead, allow for existence of additional factors not necessarily expressly described, again, depending at least in part on context.

The detailed description provided herein is not intended as an extensive or detailed discussion of known concepts, and as such, details that are known generally to those of ordinary skill in the relevant art may have been omitted or may be handled in summary fashion. Certain embodiments of the present disclosure will now be discussed with reference to the aforementioned figures, wherein like reference numerals refer to like components.

In general, the present disclosure includes a search assist system, apparatus, method and architecture. In accordance with one or more such embodiments, a search assist mechanism may provide one or more suggested search query completion alternatives that are selectable by the user in completing the user's search query.

Embodiments of the present disclosure consider a local intent of a partial search query in determining a set of search query completion suggestions, or set of suggested query completions, for presentation to a user in response to received input from the user representing a partial search query. A partial search query may comprise search query input received prior to receiving a user's input indicating completion of the search query input. Embodiments of the present disclosure may provide a number of search query completion suggestions in response to input typed by the user prior to the user completing the search query input, where such completion may be indicated by the user selecting a submit button, search button, or other user input requesting a search and/or indicating completion of the user's search query input. The one or more suggested query completions may be provided to the user as the user is typing, e.g., entering search criteria, so that the user may select one of the suggested query completion alternatives as the search criteria that the user wishes to submit to a search engine.

In accordance with one or more embodiments of the present disclosure, a search assist, or search assistant, may be used with a general web search engine, a local web search engine, etc. By way of a non-limiting example, the search assistant may be used to present the user with a number of search query completion suggestions. The possible suggestions may comprise local business query completion suggestions, each of which may correspond to a local business, and general query completion suggestions, each of which may correspond to a general query.

A ranking of local business query completion suggestions and general query completion suggestions may be used to identify a number of top-ranked query completion suggestions for presentation to the user. The ranking may use a popularity measure associated with each business and a frequency measure associated with each general query. A general query's frequency may be determined using historic information, such as query logs storing information about previously-submitted queries, corresponding search results and search result click, or selection, information. A business's popularity may be determined using such information as reviews and/or ratings of the business, e.g., such as may be provided by users using an online review website, comments about the business, which may be provided by users using an online review site, number of searches for the business, number of clicks, or selections, of a search result associated with the business, etc. A popularity associated with a local business may be weighted using a granularity weighting, which may be determined using a local query intent confidence level, A local query intent confidence level may be determined using a partial search query input length.

In accordance with one or more embodiments, the one or more local business query completion alternatives may be selected for presentation, e.g., display, to the user as part of the suggested query completion alternatives based on such information as the user's geographic location, a business's geographic location, and a business's popularity relative to the popularity of other businesses and relative to the frequency of general search queries. The one or more popular local businesses may be presented as suggested local business query completions, which may be presented to the user along with one or more suggested general search query completions.

In accordance with one or more embodiments, a determination of what is considered to be a local business may be determined relative to a geographic location of a user associated with received partial search query input. Embodiments of the present disclosure may make a determination of what is considered to be local at varying levels, such as and without limitation at city, direct market area, country, and etc. levels.

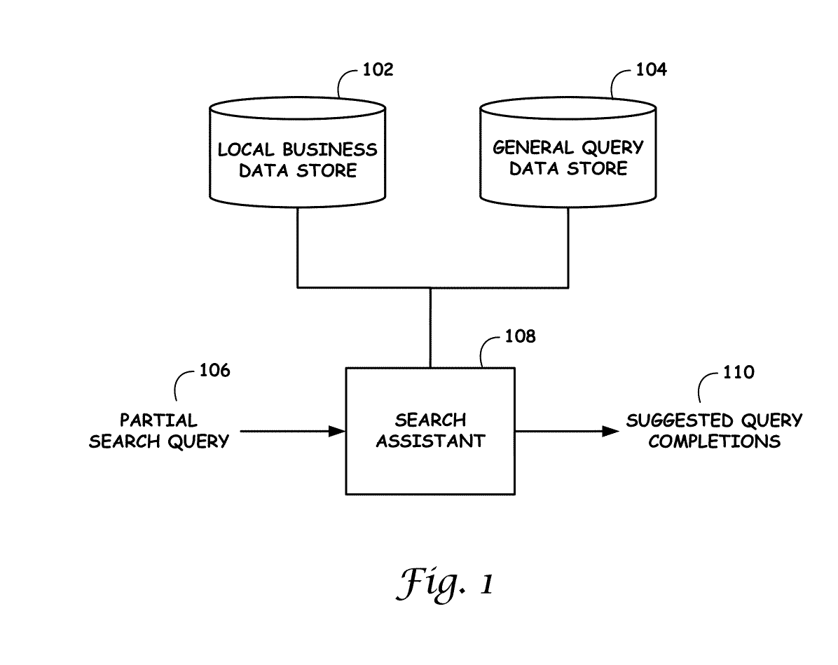

FIG. 1 provides an overview of components for use in accordance with one or more embodiments of the present disclosure. In the example shown in FIG. 1, a search assistant 108 receives a partial search query 106 and makes one or more suggested query completion 110 available in response.

By way of a non-limiting example, partial search query 106 may be received from a user via the user's computing device. The user's computing device may comprise an application that provides a user interface to receive the user's partial search query 106. The application may be a browser application that displays a user interface in the form of a web page associated with website and/or a web search engine. The web page may comprise at least one input field via which the user may input the partial search query 106. The web page may further comprise a button, or other user interface control, which the user may use to submit a complete search query. The complete search query may be a user-selected one of the suggested query completions 110.

The application may forward the partial search query 106 to the search assistant 108 before the user selects the user interface control indicating completion of the search query. Additionally, the application may receive the suggested query completions 110 generated by the search assistant 108, and provide the suggested query completions 110 to the user in the application's user interface, as the user enters the partial search query 106. The suggested query completions 110 may be updated in response to changes, e.g., additions and/or modifications, made to the partial search query 106 by the user. The suggested query completions 110 comprise one or more suggested query completions that may be selected by the user as the user's completed search query. By way of a non-limiting example, each one of the suggested query completions 110 includes information that may augment the user's partial search query 106. The user interface may display each suggested query completion, which suggested query completion may include the partial search query 106, as a selectable option to the user. A listing of the suggested query completions 110 may be provided to the user via the application's user interface.

While embodiments of the present disclosure are described in connection with a web, or Internet, searching using a web browser, it should be apparent that any type of searching of any type of data may be assisted using the search assist functionality.

In the example of FIG. 1, search assistant 108 may use local business data store 102 and general query data store 104 to identify the suggested query completions 110. By way of a non-limiting example, the partial search query 106 may be used to search one or both of data stores 102 and 104 to identify one or more local businesses and/or general queries from the data stores 102 and 104, respectively.

Local business data store 102 may comprise any information about each business of a plurality of businesses. By way of a non-limiting example, data store 102 may comprise some or all of such items of information has business name, business location, and a popularity score. By way of some further non-limiting examples, data store 102 may comprise information items used to generate a business's popularity score, which information may comprise some or all of such items as one or more ratings, a number, or count, of comments, a number, or count, of searches, and the number, or count, of clicks. A business's rating(s) and/or number of comments might be retrieved from one or more websites, such as Yelp™, Yahoo!™ local search, online review sites, etc. The number of searches and/or clicks may be determined using query logs of one or more search engines, such as and without limitation general search engines, local search engines, etc.

In accordance with one or more embodiments, search assistant 108 may determine the suggested query completion(s) 110 using the partial search query 106, a geographic location associated with the user, and a geographic location associated with each of one or more businesses, e.g., one or more businesses having data stored in data store 102. By way of a non-limiting example, the user's geographic location might be determined using an Internet Protocol (IP) address associated with the user's computing device, user information retrieved from the user's computing device, such as and without limitation information stored in a cookie, user information associated with a user account associated with the user, Global Positioning System (GPS) information generated by a GPS component of the user's computing device or other device associated with the user, etc.

In accordance with one or more embodiments, the user's associated geographic location may be used to identify a set of local businesses, each of which has a geographic location that is determined to be a match for the user's geographic location. By way of a example, the user's geographic location may specify a city, or other geographic region or area, which might be used to identify one or more businesses' located in the same city, or other geographic region or area. Other examples of geographic regions, or areas, include but are not limited to a designated marketing area (DMA, state, county, country, etc. A DMA may be any geographic area, or a combination of two or more geographic areas, considered to make up a particular media market, e.g., such as and without limitation one or more of television, radio, print, interact etc. media market(s). A population within a given DMA may receive the same or similar content, including advertising content. A DMA may comprise one or more cities, one or more counties, etc.

By way of a non-limiting example, yo yo may be received as a partial search query 106 from a user whose geographic location is identified as Santa Clara, Calif. The partial search query 106 may be used to search for names of businesses considered to be “local” to the user, such as businesses located in the Santa Clara, Calif., in a DMA that includes Santa Clara, Calif., in the state of California, in Santa Clara county, in the United States, etc. The partial search query 106 might be used to identify a business whose name includes yo yo, such as a sushi restaurant named Yo Yo Sushi, located in Santa Clara, Calif., together with other businesses from data store 102 and/or general queries from data store 104. Some examples of general queries that might be identified for the partial search query 106 are yo yo honey singh, yo yo ma, yo yo tricks, yo dieting, etc.

A set of general queries and a set of local business names, including Yo Yo Sushi, may be ranked to generate a ranking listing. Assuming, for the sake of example, that one or more local businesses and one or more general queries are identified for the partial search query 106, the one or more local businesses and one or more general queries may be blended, or merged, in a ranking, where each local business is ranked based on its popularity and each general query is ranked based on its frequency. The ranking may be used to identify a number, n, of the top-ranked entries in the ranking. The entry associated with the Yo Yo Sushi restaurant might be selected as one of the suggested query completions 110 where the local business's popularity is such that its associated entry is among the top n ranked items in the ranking. By way of a non-limiting example, the suggested query completion associated with the Yo Yo Sushi restaurant presented to the user as one of the suggested query completions 110 might be yo yo sushi Santa Clara.

In accordance with one or more embodiments, search assistant 108 may be performed by any one or more computing devices. By way of a non-limiting example, search assistant 108 may be implemented by one or more server computing devices, the user's computing device, etc.

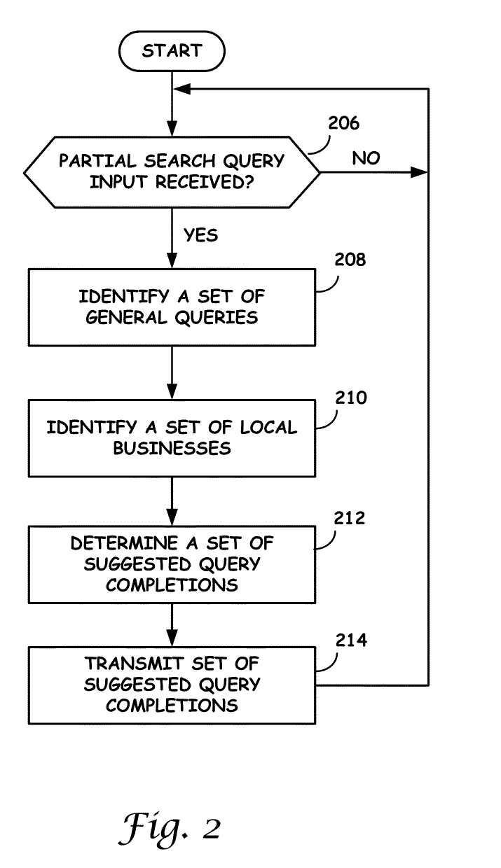

FIG. 2 provides an example of a process flow in accordance with one or more embodiments of the present disclosure. The process flow of FIG. 2 may be performed by search assistant 108.

In the example of FIG. 2, a determination is made at step 206 whether or not a partial search query 106 is received. If not, processing awaits receipt of the partial search query 106. By way of a non-limiting example, the partial search query 106 may be received using an application, e.g., a browser application, executing at the user's client device. If it is determined, at step 206, that the partial search query 106 has been received, processing continues, at step 208, to identify a set of general queries, which set may comprise none or more general queries. By way of a non-limiting example, the set of general queries may be identified using the partial search query 106 as search criteria to search the general query data store 104. Processing continues at step 208.

At step 208, a set of local businesses, which set may comprise none or more local businesses. By way of a non-limiting example, the set of local businesses may be identified using the partial search query 106 as search criteria to search the local business data store 102. Processing continues at step 212 to determine the set of suggested query completions 110 using the set of general queries and the set of local businesses. The set of suggested query completions 110 may be determined from a ranking using a frequency associated with each general query in the set of general queries and the popularity associated with each local business in the set of local businesses.

At step 214, the set of suggested query completions 110 may be made available to the user. By way of a non-limiting example, the set of suggested query completions 110 may be output from the search assistant 108, which output may be transmitted to the application, e.g., a browser application, executing at the user's computing device, from which the partial search query 106 was received. By way of a non-limiting example, functionality associated with search assistant 108 may be provided by one or more server computing devices, and the suggested query completions 110 may be transmitted to a browser, or other, application executing on the user's computer device via one or more networks, including the internet.

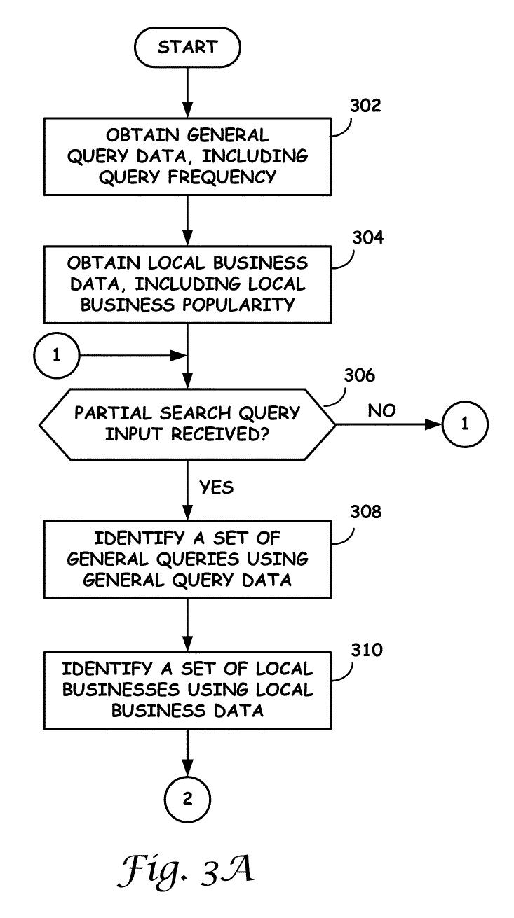

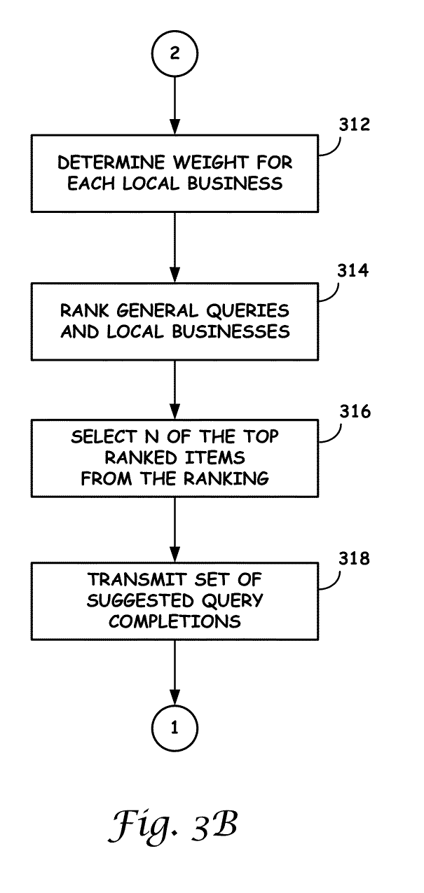

FIG. 3, which comprises FIGS. 3A and 3B, provides another example of a process flow in accordance with one or more embodiments of the present disclosure. In the example of FIG. 3, search assistant 108, or another component, may be used, at step 302, to generate, or otherwise obtain, local business data store 102 and/or may be used, at step 304, to generate, or otherwise obtain, general query data store 104. Other steps of FIG. 3 may be performed by search assistant 108, which may be implemented by one or more computing devices.

As discussed herein, local business data store 102 comprises a popularity score for each business identified in the data store. In accordance with one or more embodiments, a business's popularity may be determined using a learning module, such as a linear model, which takes as input features of the business and provides a popularity score as output. By way of a non-limiting example, the popularity score may be normalized and/or may comprise a value that is within a range of 0 to 1, where zero may represent a lowest popularity, or least popular, score, and one may represent a greatest popularity, or most popular, score, or vice versa.

By way of a non-limiting example, a business's popularity score may be estimated, predicted, learned, etc. using features of the business, which features may comprise a rating feature comprising one or more ratings of the business, a comment feature comprising a count, or number, of comments about the business, a frequency feature comprising number, or count, of searches for the business, a click feature comprising a count, or number, of search result clicks, or selections, associated with the business, etc. The one or more features of the business may be used as information input to the learning model to generate the business's popularity score. By way of a non-limiting example, the learning model may determine a value for each feature and generate the popularity score by aggregating the feature values. A weighting may be applied to a feature, which weighting may be the same or different for different features. By way of a example, a feature's weighting may be applied to the feature's score to generate a weighted feature score, which weighted feature score may be used in aggregating the feature values.

At step 306, a determination is made whether or not partial search query input has been received. If not, processing continues at step 306 to await such input. If it is determined, at step 306, that a partial search query 106 has been received, processing continues at step 308. At step 308, a set of general queries may be identified, e.g., by searching the general query data store 104 using the partial search query 106. At step 310, a set of local businesses may be identified, e.g., by searching the local business data store 102 using the partial search query 106.

Processing continues at step 312 of FIG. 3B, to determine a granularity weight for each local business. In accordance with one or more embodiments, one or more levels of geographic location granularity may be used in matching the user's geographic location and the business's to identify whether or not the business is local business with respect to the user. By way of a non.-limiting example, levels of granularity may comprise city, DMA, country, all, etc. A granularity weighting may be applied to a business's popularity score, which weighting may be determined using a level of confidence that the user's partial search query 106 is intended to be a local search, e.g., a search for a local business. A level of confidence may be determined based on the length, e.g., in characters, of the partial search query 106. In accordance with one or more embodiments, a strength of, or confidence in, the local intent of the partial search query 106 may be clearer as the length of the partial search query 106 increases. Conversely, local intent may be less clear where the length of the partial search query 106 is considered to be short.

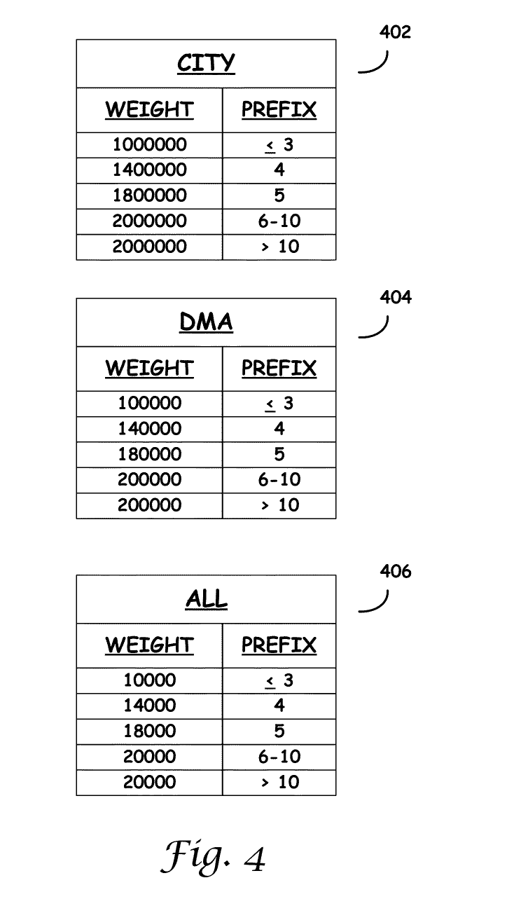

In accordance with one or more embodiments, the granularity weighting may be determined based on the level of granularity and the length of the partial search query 106. FIG. 4 provides examples of various weights that may be applied to a popularity score in accordance with one or more embodiments of the present disclosure. in the example of FIG. 4, table 402 comprises a set of weightings associated with a city level of granularity, table 404 comprises a set of weightings associated with a DMA level of granularity, and table 406 comprises a set of weightings associated with an “all” level of granularity. The “all” level of granularity may apply in instances where a lower level of granularity is unavailable, or not applicable, such as in a case that the user's location and the business's location are not within the same city or DMA.

In the example of table 402, which is associated with a city level of granularity, the granularity weighting is determined by a prefix length, which is the length, e.g., number of characters, of the partial search query 106. By way of a non-limiting example, where the partial search query 106 is no more than three characters in length and the local business's location and the user's location is within the same city, a weighting of 1 million may be applied to the local business's popularity score. Assuming, for the sake of a non-limiting example, that the local business's location and the user's location is within the same DMA and the partial search query 106 is no more than three characters in length, a weighting of 100,000, e.g., one-tenth ( 1/10) of the city-level granularity weighting, may be applied to the business's popularity score. As yet another non-limiting example, where the local business's location and the user's location are not within the same city or DMA and the partial search query 106 is no more than three characters in length, a weighting of 10000, e.g., one-tenth ( 1/10) of the DMA-level granularity weighting, may be applied to the business's popularity score.

As can be seen from the example shown in FIG. 4, a granularity weighting may be determined in accordance with the user's location and the business's location and the length of the partial search query 106. It should be apparent, that any weighting may be associated with any partial search query length and/or level of geographic locations granularity. Additionally, such a weighting may be optional.

Referring again to FIG. 3B, any general queries in the set of general queries and any local businesses in the set of local businesses are ranked together to form a ranked order, e.g., a ranked listing, from which a number, n, of the top-ranked items may be selected to form the set of suggested query completions 110. In accordance with one or more embodiments, a local business's popularity, which popularity may be weighted using a granularity weighting, may be used to determine the local business's position in the ranking, and a general query's frequency may be used to determine the local query's position in the ranking.

At step 318, the set of suggested query completions 110 are provided to the user. By way of a non-limiting example, the set of suggested query completions 110 may be transmitted to the user's computing device by the search assistant 108 and/or another component.

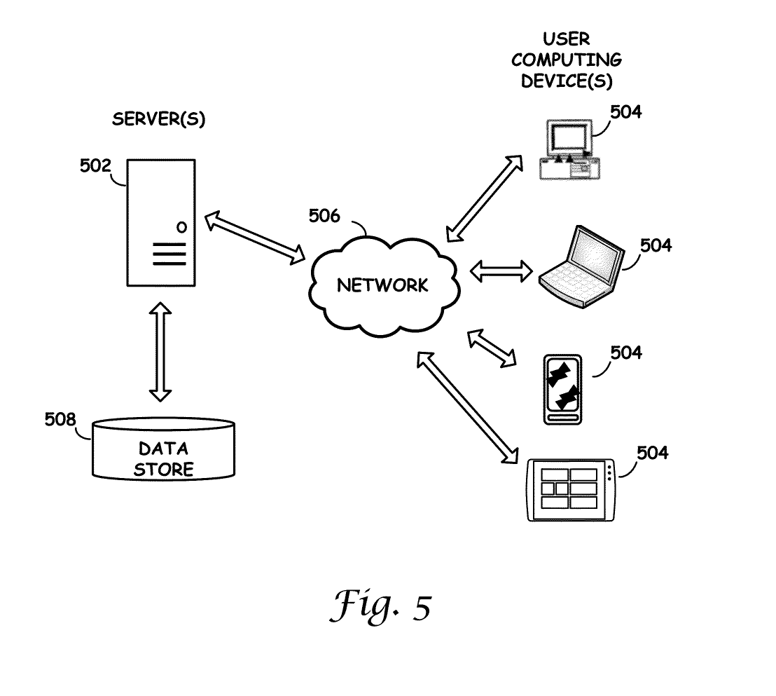

FIG. 5 illustrates some components that may be used in connection with one or more embodiments of the present disclosure. In accordance with one or more embodiments of the present disclosure, one or more computing devices, e.g., one or more servers, user devices or other computing device, are configured to comprise functionality described herein. For example, a computing device 502 may be configured to execute program code, instructions, etc. to provide functionality in accordance with one or more embodiments of the present disclosure. The same or another computing device 502 may be configured to execute program code to implement functionality in accordance with one or more embodiments of the present disclosure.

Computing device 502 may serve content to user computing devices 504 using a browser application via a network 506. Data store 508, which may include data stores 102 and/or 104, may be used to store program code to configure a server 502 to functionality in accordance with one or more embodiments of the present disclosure. By way of a. non-limiting example, content that may be served to the user computing devices 504 may include the suggested query completions 110.

The user computing device 504 may be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 502 and the user computing device 504 can include one or more processors, memory, a removable media reader, network interface, display and interface, and one or more input devices, e.g., keyboard, keypad, mouse, etc. and input device interface, for example. One skilled in the art will recognize that server 502 and user computing device 504 may be configured in many different ways and implemented using many different combinations of hardware, software, or firmware.

In accordance with one or more embodiments, a computing device 502 can make a user interface available to a user computing device 504 via the network 506. The user interface made available to the user computing device 504 can include content items, or identifiers (e.g., URLs) selected for the user interface in accordance with one or more embodiments of the present invention. In accordance with one or more embodiments, computing device 502 makes a user interface available to a user computing device 504 by communicating a definition of the user interface to the user computing device 504 via the network 506. The user interface definition may be specified using any of a number of languages, including without limitation a markup language such as Hypertext Markup Language, scripts, applets and the like. The user interface definition may be processed by an application executing on the user computing device 504, such as a browser application, to output the user interface on a display coupled, e.g., a display directly or indirectly connected, to the user computing device 504.

In an embodiment the network 506 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

As discussed, a network may couple devices so that communications may be exchanged, such as between a server computing device and a client computing device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UNITS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network. via a network access node, for example. A signal packet communicated via the Internet may, for example, be routed via a path of gateways, servers, etc. that may route the signal packet in accordance with a target address and availability of a network path to the target address.

It should be apparent that embodiments of the present disclosure may be implemented in a client-server environment such as that shown in FIG. 5. Alternatively, embodiments of the present disclosure may be implemented with other environments. As one non-limiting example, a peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration A, peer-to-peer network may employ some nodes capable of operating as both a “client” and a “server.”

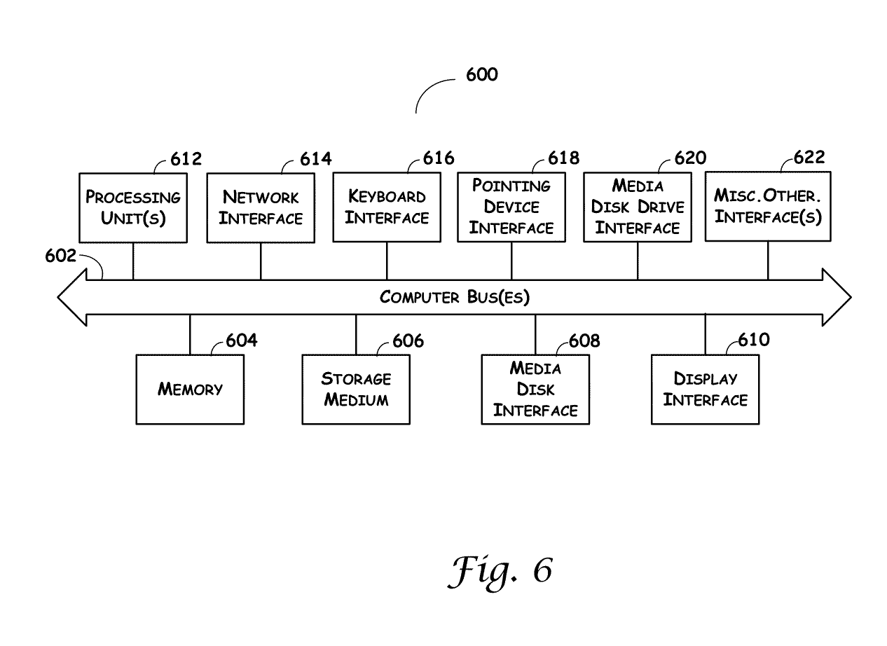

FIG. 6 is a detailed block diagram illustrating an internal architecture of a computing device, e.g., a computing device such as server 502 or user computing device 504, in accordance with one or more embodiments of the present disclosure. As shown in FIG. 6, internal architecture 600 includes one or more processing units, processors, or processing cores, (also referred to herein as CPUs) 612, which interface with at least one computer bus 602. Also interfacing with computer bus 602 are computer-readable medium, or media, 606, network interface 614, memory 604, e.g., random access memory, (RAM), run-time transient memory, read only memory (ROM), etc., media disk drive interface 620 as an interface for a drive that can read and/or write to media including removable media such as floppy, CD-ROM, DVD, etc. media, display interface 610 as interface for a monitor or other display device, keyboard interface 616 as interface for a keyboard, pointing device interface 618 as an interface for a mouse or other pointing device, and miscellaneous other interfaces not shown individually, such as parallel and serial port interfaces, a universal serial bus (USB) interface, and the like.

Memory 604 interfaces with computer bus 602 on as to provide information stored in memory 604 to CPU 612 during execution of software programs such as an operating system, application programs, device drivers, and software modules that comprise program code, and/or computer-executable process steps, incorporating functionality described herein, e.g., one or more of process flows described herein. CPU 612 first loads computer-executable process steps from storage, e.g., memory 604, computer-readable storage medium/media 606, removable media drive, and/or other storage device. CPU 612 can then execute the stored process steps in order to execute the loaded computer-executable process steps. Stored data, e.g., data stored by a storage device, may be accessed by CPU 612 during the execution of computer-executable process steps.

Persistent storage, e.g., medium/media 606, may be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, MD, or other optical storage, magnetic cassettes, magnetic tape, magnetic disk storage or other magnetic storage devices, or any other physical or material medium which may be used to tangibly store the desired information or data or instructions and which may be accessed by a computer or processor.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
receiving, by at least one computing device, user input indicative of a partial search query;
identifying, by the at least one computing device, a set of general queries;
identifying, by the at least one computing device, a set of local businesses, each local business is determined to be local to the user;
determining, by the at least one computing device, a set of suggested query completions, using the set of general queries and the set of local businesses, the determining using a frequency associated with each general query of the set and a popularity associated each local business of the set; and
making, by the at least one computing device, the set of suggested query completions available to the user in response to the user input.

2. The method of claim 1, further comprising:
determining, by the at least one computing device and for each general query of a plurality of queries, the frequency of the general query;
determining, by the at least one computing device and for each business of a plurality of businesses, the popularity of the business being determined by aggregating a set of values determined for a set of features associated with the business to generate a measure of the popularity of the business.

3. The method of claim 2, the features comprising at least one rating for he business from at least one online review site.

4. The method of claim 2, the features comprising at least a number of comments about the business.

5. The method of claim 2, the features comprising at least a number of searches for the business determined from at least one query log.

6. The method of claim 2, the features comprising at least a number of clicks, the number of clicks representing the number of search results selections about the business.

7. The method of claim 1, further comprising:
determining, by the at least one computing device, the set of local businesses, the determining using the geographic location associated with the user and a geographic location of each of a plurality of businesses;
the identifying a set of local businesses further comprising selecting from the set of local businesses using the popularity of each local business in the set.

8. The method of claim 1, the determining further comprising:
generating, by the at least one computing device, an aggregate ranking of the sets of local businesses and general queries, the aggregate ranking using the popularity associated with each business of the set and the frequency associated with each general query of the set; and
determining the set of suggested query completions using the aggregate ranking, such that a number of top-ranked entries are selected from the aggregate ranking.

9. The method of claim 1, further comprising:
determining a weighting associated with each local business's popularity, the weighting representing a local business intent of the partial search query.

10. The method of claim 9, the local business intent is a function of the length of the partial search query, and the weighting increases as confidence in the local business intent of the partial search query increases.

11. The method of claim 9, the weighting is at least partially based on a shared geographic region determined for the user and the business.

12. The method of claim 11, the shared geographic region is one of a city, a designated market area and a country.

13. A system comprising:
at least one computing device comprising one or more processors to execute and memory to store instructions to:
receive user input indicative of a partial search query;
identify a set of general queries;
identify a set of local businesses, each local business is determined to be local to the user;
determine a set of suggested query completions, using the set of general queries and the set of local businesses, the determining using a frequency associated with each general query of the set and a popularity associated each local business of the set; and
make the set of suggested query completions available to the user in response to the user input.

14. The system of claim 13, the instructions further comprising instructions to:
determine, for each general query of a plurality of queries, the frequency of the general query;
determine, for each business of a plurality of businesses, the popularity of the business being determined by aggregating a set of values determined for a set of features associated with the business to generate a measure of the popularity of the business.

15. The system of claim 14, the features comprising at least one rating for the business from at least one online review site.

16. The system of claim 14, the features comprising at lead a number of comments about the business.

17. The system of claim 14, the features comprising at least a number of searches tier the business determined from at least one query log.

18. The system of claim 14, the features comprising at least a number of clicks, the number of clicks representing the number of search results selections about the business.

19. The system of claim 13, the instructions further comprising instructions to:
determine the set of local businesses using the geographic location associated with user and a geographic location of each of a plurality of businesses;
the instructions to identify a set of local businesses further comprising instructions to select from the set of local businesses using the popularity of each local business in the set.

20. The system of claim 13, the instructions to determine further comprising instructions to:
generate an aggregate ranking of the sets of local businesses and general queries, the aggregate ranking using the popularity associated with each business of the set and the frequency associated with each general query of the set; and
determine the set of suggested query completions using the aggregate ranking, such that number of top-ranked entries are selected from the aggregate ranking.

21. The system of claim 13, the instructions further comprising instructions to:
determine a weighting associated with each local business's popularity, the weighting representing a local business intent of the partial search query.

22. The system of claim 21, the local business intent is a function of the length of the partial search query, and the weighting increases as confidence in the local business intent of the partial search query increases.

23. The system of claim 21, the weighting is at least partially based on a shared geographic region determined for the user and the business.

24. The system of claim 23, the shared geographic region is one of a city, a designated market area and a country.

25. A computer readable non-transitory storage medium for tangibly storing thereon computer readable instructions that when executed cause at least one processor to:
receive user input indicative of a partial search query;
identify a set of general queries;
identify a set of local businesses, each local business is determined to be local to the user;
determine a set of suggested query completions, using the set of general queries and the set of local businesses, the determining using a frequency associated with each general query of the set and a popularity associated each local business of the set; and
make the set of suggested query completions available to the user in response to the user input.

26. The computer readable non-transitory storage medium of claim 25, the instructions further comprising instructions to:
determine, for each general query of a plurality of queries, the frequency of the general query;
determine, for each business of a plurality of businesses, the popularity of the business being determined by aggregating a set of values determined fir a set of features associated with the business to generate a measure of the popularity of the business.

27. The computer readable non-transitory storage medium of claim 26, the features comprising at least one rating for the business from at least one online review site.

28. The computer readable non-transitory storage medium of claim 26, the features comprising at least a number of comments about the business.

29. The computer readable non-transitory storage medium of claim 26, the features comprising at least a number of searches for the business determined from at least one query log.

30. The computer readable non-transitory storage medium of claim 26, the features comprising at least a number of clicks, the number of clicks representing the number of search results selections about the business.

31. The computer readable non-transitory storage medium of claim 25, the instructions further comprising instructions to:
determine the set of local businesses using the geographic location associated with the user and a geographic location of each of a plurality of businesses;
the instructions to identify a set of local businesses further comprising instructions to select from the set of local businesses using the popularity of each local business in the set.

32. The computer readable non-transitory storage medium of claim 25, the instructions to determine further comprising instructions to:
generate an aggregate ranking of the sets of local businesses and general queries, the aggregate ranking using the popularity associated with each business of the set and the frequency associated with each general query of the set; and
determine the set of suggested query completions using the aggregate ranking, such that a number of top-ranked entries are selected from the aggregate ranking.

33. The computer readable non-transitory storage medium of claim 25, the instructions further comprising instructions to:
determine a weighting associated with each local business's popularity, the weighting representing a local business intent of the partial search query.

34. The computer readable non-transitory storage medium of claim 33, the local business intent is a function of the length of the partial search query, and the weighting increases as confidence in the local business intent of the partial search query increases.

35. The computer readable non-transitory storage medium of claim 33, the weighting is at least partially based on a shared geographic region determined for the user and the business.

36. The computer readable non-transitory storage medium of claim 35, the shared geographic region is one of a city, a designated market area and a country.
